(19) United States
(12) Patent Application Publication
(10) Pub. No.: US 2015/0116860 A1
(43) Pub. Date: Apr. 30, 2015

(54) SYSTEM AND METHODS FOR COMBINING MULTIPLE OFFSET READ-BACKS

(71) Applicant: HGST Netherlands B.V., Amsterdam (NL)

(72) Inventors: Jonathan Darrel COKER, Rochester, MN (US); Richard Leo GALBRAITH, Rochester, MN (US); Travis Roger OENNING, Rochester, MN (US); Roger William WOOD, Gilroy, CA (US)

(73) Assignee: HGST Netherlands B.V., Amsterdam (NL)

(21) Appl. No.: 14/065,009

(22) Filed: Oct. 28, 2013

(51) Int. Cl. G11B 20/10

(52) U.S. Cl. CPC G11B 20/10046
USPC 360/65

(57) ABSTRACT

Techniques for processing signals read-back from a disk of a hard disk drive are described. In one example, a hard disk drive device generates a signal associated with a first position within a width of the data track. The first position may correspond to the center of a data track. The hard disk drive device generates a signal associated with a second position within a width of the data track. The second position may be located at a distance of approximately 10% of the track width from the track center. The hard disk drive device combines the signals and applies as signal conditioning technique to the combined signal.

### TECHNICAL FIELD

This disclosure relates to data storage devices, and more particularly to signal processing techniques for magnetic patterns read-back from a disk of a hard disk drive.

### BACKGROUND

Data storage devices can be incorporated into a wide range of devices, including laptop or desktop computers, tablet computers, digital video recorders, set-top boxes, digital recording devices, digital media players, video gaming devices, video game consoles, cellular telephones, and the like. Data storage devices may include hard disk drives (HDD). HDDs include one or multiple magnetic disks having positive or negative areas of magnetization. Data may be represented using the positive and negative areas of magnetization. Blocks of data may be arranged to form tracks on a rotating disk surface. A magnetic transducer may be used to read data from a disk and write data to the disk. Different magnetic recording techniques may be used to store data to the disk. Magnetic recording techniques include, for example, longitudinal magnetic recording (LMR), perpendicular magnetic recording (PMR), and shingled magnetic recording (SMR). Heat assisted magnetic recording (HAMR) may be used with LMR, PMR, or SMR.

Positive and negative areas of magnetization are read-back from a disk to generate an analog signal. The signal may include noise caused by interference from one or more adjacent tracks and/or from noise introduced at the time a track was written.

### SUMMARY

In general, this disclosure describes techniques for storing data. In particular, this disclosure describes techniques for processing signals read-back from a disk of a hard disk drive.

According to one example of the disclosure, a method of processing signals read from a disk of a hard disk drive comprises generating a signal associated with a first position within a width of the data track, generating a signal associated with a second position within a width of the data track, combining the signal associated with the first position and the signal associated with the second position, and applying a finite impulse response filter to the combined signal.

According to another example of the disclosure a hard disk drive device comprises a magnetic disk including a data track written thereon, and a processing unit configured to generate a signal associated with a first position within a width of the data track, generate a signal associated with a second position within a width of the data track, combine the signal associated with the first position and the signal associated with the second position, and apply a finite impulse response filter to the combined signal.

According to another example of the disclosure a non-transitory computer-readable storage medium has instructions stored thereon that upon execution cause one or more processors of a hard disk drive device to generate a signal associated with a first position within a width of the data track, generate a signal associated with a second position within a width of the data track, combine the signal associated with the first position and the signal associated with the second position, and apply a finite impulse response filter to the combined signal.

According to another example of the disclosure an apparatus comprises means for generating a signal associated with a first position within a width of the data track, means for generating a signal associated with a second position within a width of the data track, means for combining the signal associated with the first position and the signal associated with the second position, and means for applying a finite impulse response filter to the combined signal.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example hard disk drive that may utilize the techniques described in this disclosure.

FIG. 2 is a conceptual diagram illustrating an example of a plurality of tracks written to a disk of a hard disk drive in accordance with the techniques described herein.

FIG. 3 is a conceptual diagram illustrating an example of a plurality of tracks written to a disk of a hard disk drive in accordance with the techniques described herein.

FIG. 4 is a conceptual diagram illustrating an example of a plurality of read offsets associated a track written to a disk of a hard disk drive in accordance with the techniques described herein.

FIG. 5 is a diagram illustrating a cross track pickup profile and a down track response of an example read sensor.

FIG. 6 is a block diagram illustrating example signal processing techniques described herein.

FIG. 7 is a diagram illustrating an effective cross track pickup profile and down track response of an example read sensor based on techniques described herein.

FIG. 8A is an example chart illustrated an example of an intelligent data recovery procedure (DRP) according to the techniques described herein.

FIG. 8B is an example data table corresponding to the example chart illustrated in FIG. 8A.

### DETAILED DESCRIPTION

In general, this disclosure describes techniques for processing signals read-back from a disk of a hard disk drive. In particular, this disclosure describes techniques for combining multiple signals read-back from a magnetic disk, where each of the read-back signals corresponds to an offset. In some examples, the signal processing techniques described herein may be used for improving signal-to-noise ratio (SNR). In other examples, the techniques described herein may be used for improving data recovery procedure (DRP) effectiveness.

In order to recover data written to a magnetic disk, a magnetic pattern may be read-back from a magnetic disk using an electromagnetic transducer. The signal generated from the electromagnetic transducer may be mathematically represented as a waveform. A signal may include noise caused by interference from one or more adjacent tracks or noise introduced at the time a track was written. The signal may be processed using signal processing techniques to improve the SNR of a signal. Signal processing techniques may also be used for DRP. Techniques used for improving the SNR and used for DRP include read averaging and Inter-Track Interference Cancellation (ITIC).

Read averaging is a technique where a magnetic pattern is read multiple times and the resulting signals are averaged in order to reduce electronic noise contributions in the signal. Conventional read average techniques may generate signals by repeatedly reading magnetic patterns at the same position of a magnetic disk (e.g. center of a data track). Although read averaging may reduce electronic noise, read averaging may not effectively reduce inter-track interference. ITIC cancellation is a technique where magnetic patterns from tracks adjacent to a desired track (e.g., N−1 and N+1) are recovered and an approximation of the interfering track signals are subtracted from the magnetic pattern read at track “N.” Although ITIC may reduce inter-track interference, ITIC may not effectively reduce noise contributions. Thus, this disclosure proposes signal processing techniques for reducing both inter-track interference and reducing noise.

The techniques described herein may provide equalization in both radial and tangential directions. Equalization in the radial direction can act as ITI cancellation, canceling both adjacent track signals and noise at the track seams. Further, noise correlations can degrade Viterbi detector performance during DRP and these correlations may exist in both the radial and tangential directions. The techniques described herein may be used for providing noise whitening in both the radial and tangential directions to improve DRP. The techniques of this disclosure may be particularly useful for magnetic patterns recorded to a disk using perpendicular magnetic recording (PMR) and shingled magnetic recording (SMR) techniques.

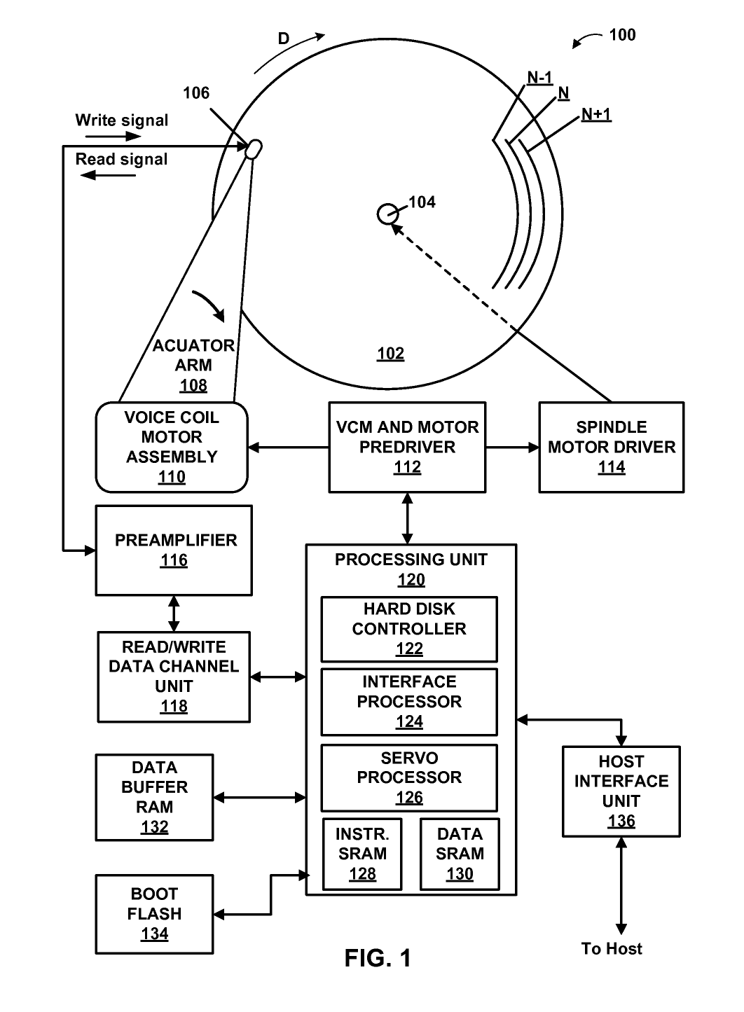

FIG. 1 is a conceptual diagram illustrating an example hard disk drive that may utilize the techniques described in this disclosure. Hard disk drive 100 may be operably coupled to a host device as an internal or external data storage device. A host device may include, for example, a laptop or desktop computer or a similar device. Hard disk drive 100, includes data recording disk or medium 102, spindle assembly 104, slider 106, actuator arm 108, voice coil motor assembly 110, VCM and motor predriver 112, spindle motor driver 114, preamplifier 116, read/write data channel unit 118, processing unit 120, data buffer RAM 132, boot flash 134, and host interface unit 136. Further, processing unit 120 includes hard disk controller 122, interface processor 124, servo processor 126, instruction SRAM 128, and data SRAM 130. It should be noted that although example hard disk drive 100 is illustrated as having distinct functional blocks, such an illustration is for descriptive purposes and does not limit hard disk drive 100 to particular hardware architecture. In a similar manner, processing unit 120 should not be limited to a particular hardware architecture based on the example illustrated in FIG. 1. Functions of hard disk drive 100 may be realized using any combination of hardware and/or software implementations.

Disk 102 includes a stack of one or more disks having magnetic material deposited on one or both sides thereof. Disk 102 may be composed of a light aluminum alloy, ceramic/glass, or other suitable substrate that magnetic material may be deposited thereon. Using electromagnetic techniques, data may be stored on disk 102 by orientating an area of the magnetic material. Data stored on disk 102 may be organized as data blocks. Data blocks are typically 512 bytes or 4 KB in size, but may be other sizes as well. The data written to disk 102 may be arranged into a set of radially-spaced concentric tracks, illustrated in FIG. 1 as N−1, N, and N+1. A data block may be located within a sector of a particular track.

Magnetic material of disk 102 may be configured according to one a plurality magnetic recording techniques. Examples of magnetic recording techniques include longitudinal magnetic recording (LMR) and perpendicular magnetic recording (PMR). Additional magnetic recording techniques include shingled magnetic recording (SMR) and heat assisted magnetic recording (HAMR). SMR is a type of PMR that increases bit density compared to conventional PMR by allowing tracks to be written in a manner that allows overlap of one or more adjacent tracks. HAMR may be used in conjunction with LMR, PMR, or SMR techniques to achieve higher areal storage density.

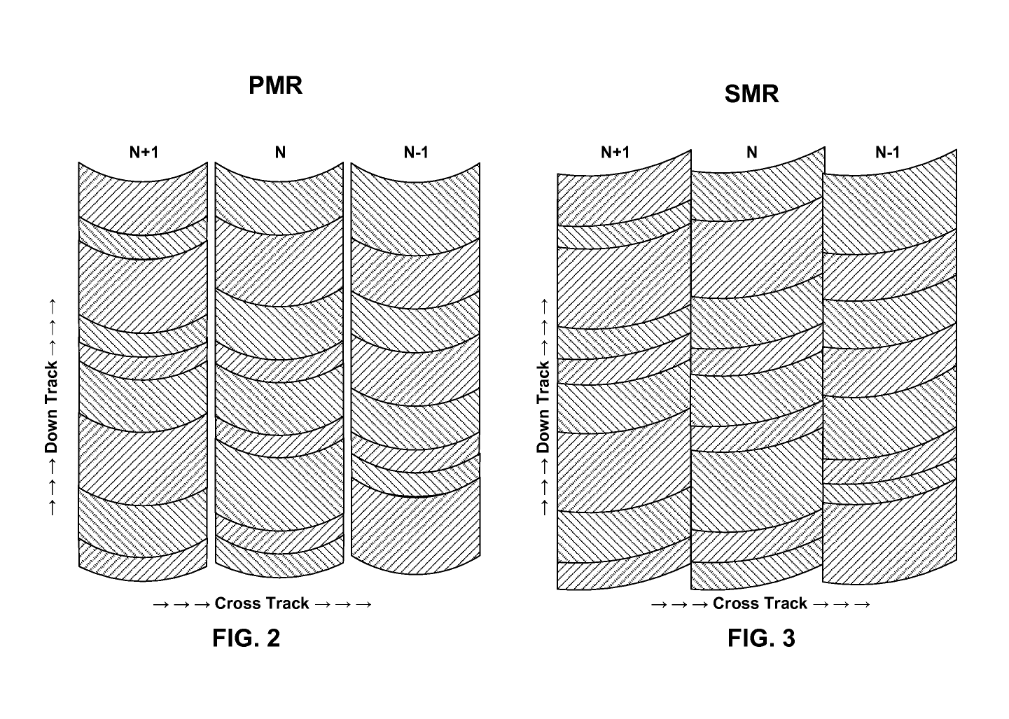

FIG. 2 is a conceptual diagram illustrating an example of a plurality of tracks written to a disk of a hard disk drive in accordance with the techniques described herein. FIG. 2 illustrates tracks written to disk 102 using PMR wherein the sections parallel angled lines represent respective positive and negative areas of magnetization. As described in greater detail below, noise contributions may vary in both the down track (i.e., tangential) and cross track (i.e., radial) directions. In the example illustrated in FIG. 2, the tracks are generally symmetric about the down track direction. FIG. 3 is a conceptual diagram illustrating an example of a plurality of tracks written to a disk of a hard disk drive in accordance with the techniques described herein. FIG. 3 illustrates tracks written to disk 102 using SMR wherein the cross hashes represent respective positive and negative areas of magnetization. In the example illustrated in FIG. 3, tracks are not symmetric about the down track direction. As is typically the case with SMR tracks, even with the write and read magnetic transducers (also referred to as sensors or heads) at zero skew angle, the magnetic patterns are not normally written parallel to the read sensor. This may result in in SNR loss. Further, spectral SNR due to “N−1” & “N+1” interference is not symmetric in the cross track direction.

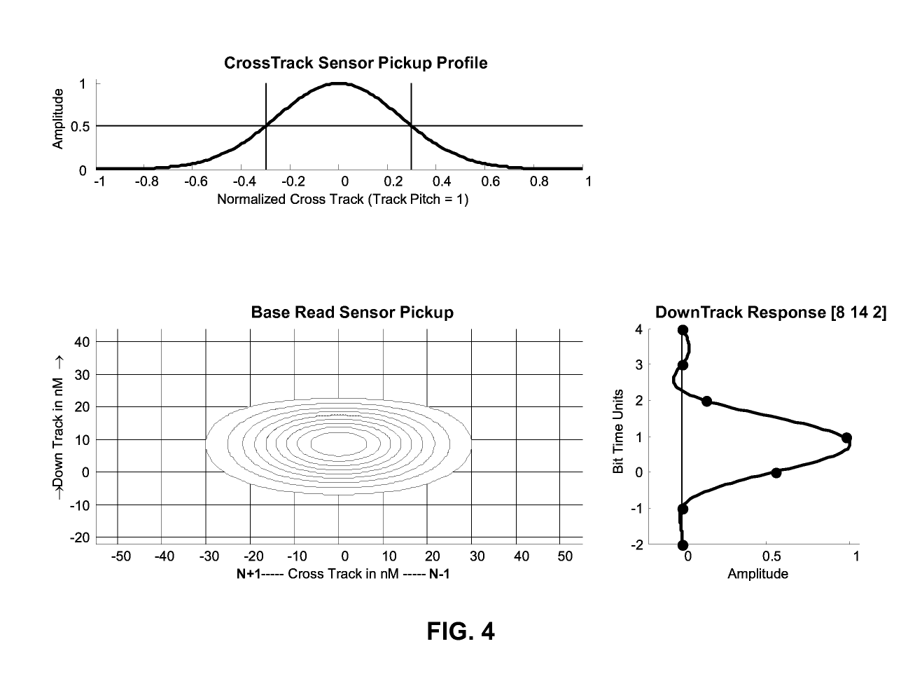

FIG. 4 is a diagram illustrating a cross track pickup profile and a down track response on an example read sensor. As illustrated in FIG. 4, for an example read sensor the normalized cross track profile follows a Gaussian distribution about the center. Further, as illustrated in FIG. 4, the down track response is approximately symmetric about the center of the read sensor. As described in greater detail below, the techniques described herein may be used to effectively “rotate” a read sensor and improve the SNR given the asymmetric nature of SMR.

Referring again to FIG. 1, disk 102 is coupled to spindle assembly 104 and rotates in direction D about a fixed axis of rotation. Disk 102 may be rotated at a constant or varying rate. Typical rates of rotation range from less than 3,600 to more than 15,000 revolutions per minute. However, disk 102 may be rotated at higher or lower rates and the rate of rotation may be determined based on a magnetic recording technique. In one example, disk 102 may be rotated at 5,400 revolutions per minute. Spindle assembly 104 includes a spindle and a motor and is coupled to spindle motor driver 114. Spindle motor driver 114 provides an electrical signal to spindle assembly 104 and the rate at which the spindle rotates, and thereby disk 102, may be proportional to the voltage or current of the electrical signal. Spindle motor driver 114 is coupled to VCM and motor predriver 112. VCM and motor predriver 112 may be configured to use feedback techniques to ensure disk 102 rotates as a desired rate. For example, VCM and motor predriver 112 may be configured to receive current and/or voltage signals from the motor and adjust the electrical signal provided to spindle motor driver 114 using feedback circuits.

As illustrated in FIG. 1, VCM and motor predriver 112 is also coupled to voice coil motor assembly 110. In addition to providing an electrical signal to spindle motor driver 114, VCM and motor predriver 112 is also configured to provide an electrical signal to voice coil motor assembly 110. Voice coil motor assembly 110 is operably coupled to actuator arm 108 such that actuator arm 108 pivots based on the current or voltage of the electrical received from signal VCM and motor predriver 112. As illustrated in FIG. 1, slider 106 is coupled to actuator arm 108. Thus, VCM and motor predriver 112 adjusts the position of slider 106 with respect to disk 102. VCM and motor predriver 112 may use feedback techniques to insure slider 106 maintains a desired position with respect to disk 102. In one example, VCM and motor predriver 112 includes an analog-to-digital converter to monitor electromagnetic fields and current from voice coil motor assembly 110.

Slider 106 is configured to read and write data to disk 102 according to a magnetic recording technique, for example, any of the example magnetic recording techniques described above. Slider 106 may include read and write heads corresponding to each of a plurality of disks included as part of disk 102. Further, slider 106 may include one or more read and write heads for each disk. Slider 106 may be configured to use a “wide write, narrow read” design. That is, a write head may be wider than a corresponding read head. Further, slider 106 may include multiple read heads corresponding to a single write head. Each read head may be positioned a various read offsets. For example, a read head may be positioned to read the center of a written track and one or more read heads may be positioned at offsets from the center of a written track (e.g, at intervals of approximately 10% of the written track width). In one example, a write head may be 11 nm by 55.

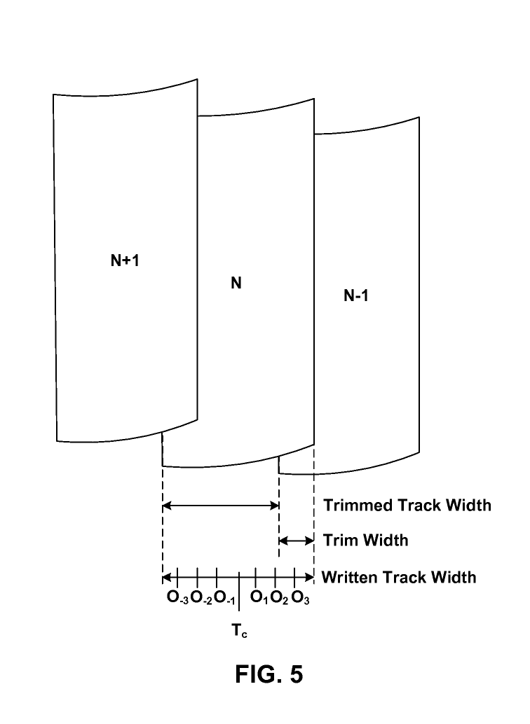

FIG. 5 is a conceptual diagram illustrating an example of a plurality of read offsets associated with tracks written to a disk of a hard disk drive in accordance with the techniques described herein. FIG. 5 illustrates tracks written to disk 102 using SMR. As illustrated in FIG. 5, tracks N−1, N, and N+1 are written in an overlapping manner, wherein N−1 is the first track written and N+1 is the last track written. The amount of overlap may be referred to as trim width and trimmed track width may be determined by subtracting the trim width from the written track width. In one example, a written track width may be approximately 40-60 nm and a trim width may be approximately 10-20 nm.

Further, as illustrated in FIG. 5, a track may include a track center, T_{c} and a plurality of offsets may be defined, i.e., O₋₃, O₋₂ . . . O₂, O₃, with respect to T_{c}. As described above, slider 106 may include multiple read heads. In one example, an offset may correspond to the position of a read head on slider 106 and magnetic patterns may be read-back at multiple offsets during a single pass. In another example, slider 106 may have a single read head corresponding to a write head and magnetic patterns from offsets may be read-back using multiple passes. In one example, offsets may be positioned at −18, −12, −6, +6, +12, and +18 nm. In another example, offsets may be positioned at intervals of approximately 10% of a track width. It should be noted that hard disk drive 100 may be configured to adaptively determine offsets. In one example, hard disk drive 100 may able to accurately select offsets within 2 nm. As described in greater detail below, hard disk drive 100 may be configured to read a track at multiple offsets in such a manner that increases SNR.

Referring again to FIG. 1, slider 106 is coupled to preamplifier 116. Preamplifier 116 may also be referred to as arm electronics (AE). Preamplifier 116 is configured to select a correct head from a plurality of heads for a particular read or write operation. Preamplifier 116 is configured to drive head 106 with a write current, during a write operation. The write current may be programmable. Further, preamplifier 116 is configured to amplify read signals from head 106, during a read operation using a programmable head bias current. Preamplifier 116 may also be configured to detect errors during each of the read and write operations. Preamplifier 116 may also include a signal adaptive filter (SAF) for thermal asperity (TA) recovery during a read operation. Preamplifier 116 receives data to be written to disk 102 from read/write data channel unit 118. Preamplifier 116 provides data read from disk 102 to read/write data channel unit 118.

As described above, a signal read-back from disk 102 may include noise and interference from adjacent tracks. Noise may include electronic noise, which is not repeatable. This type of noise usually dominates at high frequencies. Noise may also include media noise that is introduced at the time of recording. This type of noise typically dominates at low frequencies. Preamplifier 116, read/write data channel unit 118 and/or processing unit may perform signal processing techniques in order to reduce noise and/or interference from adjacent tracks in a read-back signal.

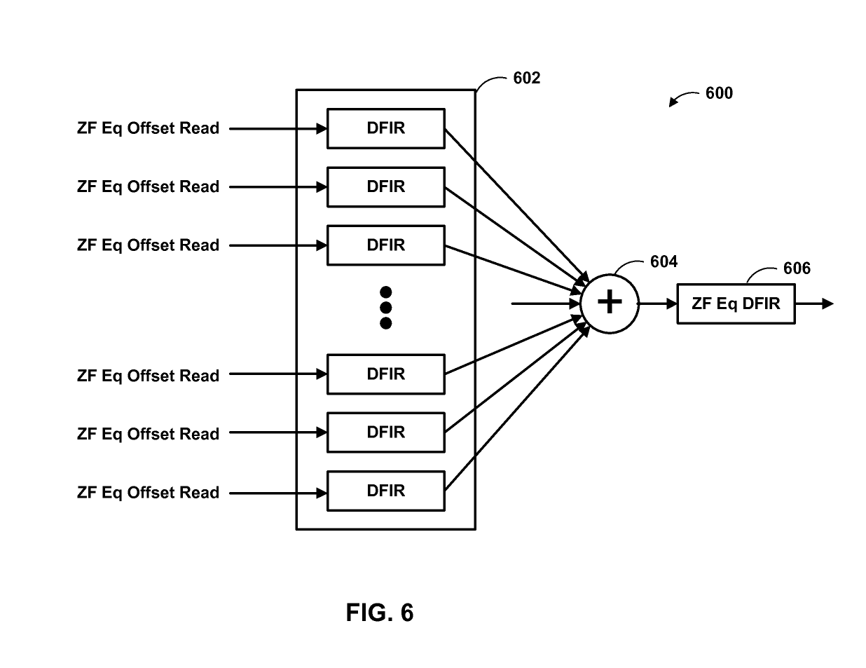

FIG. 6 is a block diagram illustrating an example signal processing techniques described herein. The signal processor 600 illustrated in FIG. 6 includes signal conditioning block 602, signal combiner 604, and combined signal conditioning block 606. As described above, a data track may be read-back from multiple offset positions within the width of a data track. As illustrated in FIG. 6, signal conditioning block 602 receives a plurality of signal read at offsets. In one example, the offsets may include the track center and offsets approximately 10% of the track width from the track center. In other examples, the offsets may include the track center and one or more offsets that may be selected to improve SNR. In the example illustrated in FIG. 6, a zero forcing equalization is applied to read-back offsets before they are received by signal conditioning block 602.

Signal conditioning block 602 includes a bank of signal conditioning blocks where each block corresponds to an offset signal. In the example illustrated in FIG. 6 the signal condition block 602 includes a discrete time finite impulse response filter (DFIR) for each offset signal. It should be noted that in other examples, signal conditioning blocks may include other types of filters. As illustrated in FIG. 6 signal combiner 604 receives a plurality of conditioned offset signals. Signal combiner 604 combines the conditioned offset signals. In one example, signal combiner 604 adds the signals. In other examples, signal combiner 604 may apply weighs to the signals before they are added.

As illustrated in FIG. 6, combined signal conditioning block 606 receives the combined signal. Combined signal conditioning block 606 conditions the combined signal. In the example illustrated in FIG. 6, combined signal conditioning block 606 performs a zero forcing equalization on the combined signal and applies a DFIR to the combined signal. That is, signal conditioning block 606 may re-equalize offset reads after they are combined. In this manner, signal processor 600 represents an example of a device configured to generate a signal associated with a first position within a width of the data track, generate a signal associated with a second position within a width of the data track, combine the signal associated with the first position and the signal associated with the second position, and apply a finite impulse response filter to the combined signal.

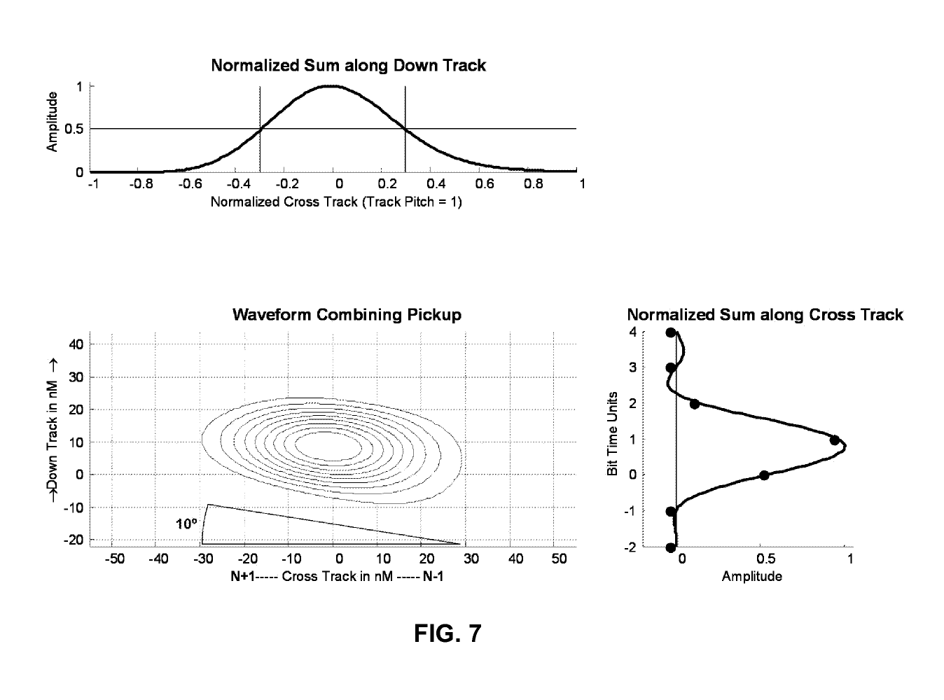

As described above, applying signal processing techniques to multiple offset reads can effectively “rotate” a read sensor and improve the SNR given the asymmetric nature of SMR. FIG. 7 is a diagram illustrating an effective cross track pickup profile and down track response on an example read sensor based on techniques described herein. FIG. 7 illustrates signal processing is performed to effective “rotate” the read sensor described above with respect to FIG. 4. As illustrated in FIG. 7, response of the read sensor illustrated in FIG. 4 is effective rotated to emphasize the data read back from track N in the N−1 cross track direction. In the example illustrated in FIG. 7, the following set of offsets was read from track N: [−18, −12, −6, 0, +6, +12, +18].

Referring again to FIG. 1, data may originate from a host device and may be communicated to read/write data channel unit 118 via host interface unit 136 and processing unit 120. Host interface unit 136 provides a connection between hard disk drive 100 and a host device. Host interface unit 136 may operate according to a physical and logical characteristics defined according to a computer bus interface. Example standardized interfaces include ATA (IDE, EIDE, ATAPI, UltraDMA, SATA), SCSI (Parallel SCSI, SAS), Fibre Channel, and PCIe (with SOP or NVMe).

As illustrated in FIG. 1, processing unit 120 includes hard disk controller 122, interface processor 124, servo processor 126, instruction SRAM 128, and data SRAM 130. Instruction SRAM 128 may store a set of operation instructions for processing unit 120. Instructions may be loaded to instruction SRAM 128 from boot flash 132 when hard disk drive is powered on. Data SRAM 130 and data buffer RAM 132, which is coupled to processing unit 120 are configured to buffer blocks of data during read and write operations. For example, blocks of data received from host interface unit 136 may be sequentially stored to data SRAM 130 and data buffer RAM 132 before the data blocks are written to disk 102. It should be noted that although instruction SRAM 128, data SRAM 130, data buffer RAM 132, and boot flash 134 are illustrated as distinct memory units, the functions of instruction SRAM 128, data SRAM 130, data buffer RAM 132, and boot flash 134 may be implemented according to other types of memory architectures.

Hard disk controller 122 generally represents the portion of processing unit 120 configured to manage the transfer of blocks of data to and from host interface unit 136 and read/write data channel unit 118. Hard disk controller 122 may be configured to perform operations to manage data buffering and may interface with host interface unit 136 according to a defined computer bus protocol, as described above. For example, hard disk controller 122 may receive and parse packets of data from host interface unit 136. Further, hard disk controller 122 may be configured to communicate with host. For example, hard disk controller 122 may be configured to report errors to host and format disk 102 based on commands received from host.

Hard disk controller 122 may be configured perform address indirection. That is, hard disk controller 122 may translate the LBAs in host commands to an internal physical address, or an intermediate address from which a physical address can ultimately be derived. It should be noted in for a hard disk drive that utilizes SMR the physical block address (PBA) of a logical block address (LBA) can change frequently. Further, for an SMR hard disk drive, the LBA-PBA mapping can change with every write operation because the hard disk drive may dynamically determine the physical location on the disk where the data for an LBA will be written.

Interface processor 124 generally represents the portion of processing unit 120 configured to interface between servo processor 126 and hard disk controller 122. Interface processor 124 may perform predictive failure analysis (PFA) algorithms, data recovery procedures, report and log errors, perform rotational positioning ordering (RPO) and perform command queuing. In one example, interface processor may be an ARM processor.

As described above, data is typically written to or read from disk 102 in blocks which are contained within a sector of a particular track. Disk 102 may also include one or more servo sectors within tracks. Servo sectors may be circumferentially or angularly-spaced and may be used to generate servo signals. A servo signal is signal read from disk 102 that may be used to align slider 106 with a particular sector or track of disk 102. Server processor 126 generally represents the portion of processing unit 120 configured to control the operation of spindle assembly 104 and voice coil motor assembly 110 to ensure slider 106 is properly positioned with respect to disk 102. Servo processor 126 may be referred to as a Servo Hardware Assist Real-time Processor (SHARP). Servo processor 126 may configured to provide closed loop control for any and all combinations of slider position on track, slider seeking, slider settling, spindle start, and spindle speed.

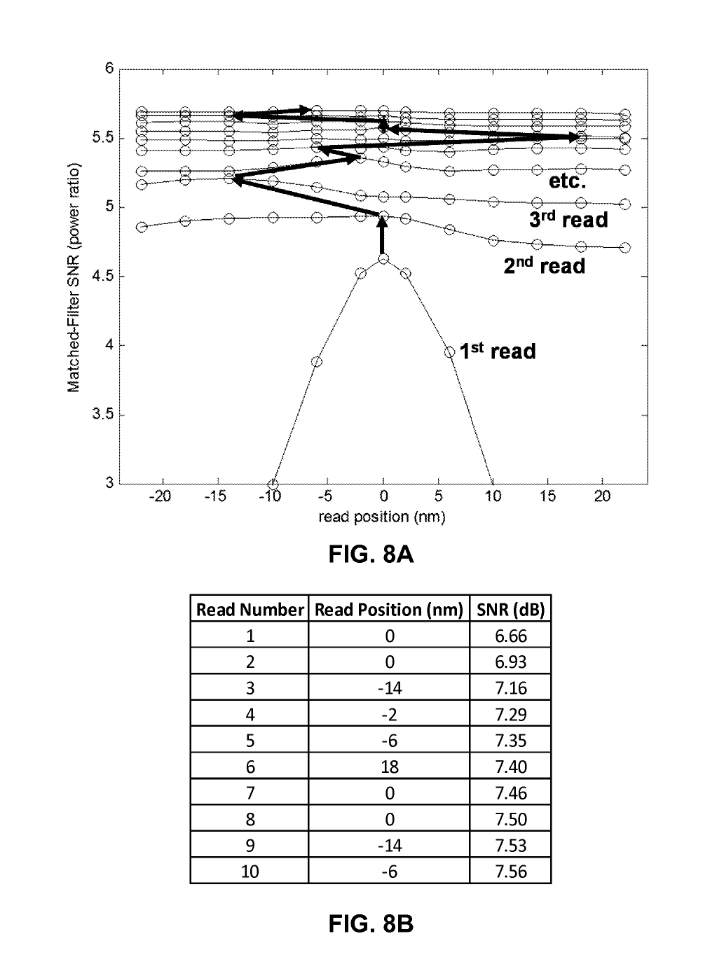

Processing unit 120 may be configured to implement DRP techniques. As described above, the signal processing techniques described herein may be used for DRP and hard disk drive 100 may be configured to adaptively determine read offsets. FIG. 8A is an example chart illustrated an example of an intelligent data recovery procedure (DRP) according to the techniques described herein. The chart illustrated in FIG. 8A illustrates a plurality of possible offsets positions for a read of a data track in a sequence of read-back. Further, the chart illustrated in FIG. 8A illustrates a corresponding matched-filter SNR corresponding to each possible read. Thus, an offset can be selected from possible offsets in a manner that maximizes the SNR for a read. FIG. 8B is an example data table corresponding to the example chart illustrated in FIG. 8A. The table illustrated in FIG. 8B illustrates the sequence of reads from possible sequences of reads that maximizes the SNR. Thus, FIG. 8A and FIG. 8B illustrate a DRP technique where the best place to take the next signal to be combined is determined to maximize SNR and minimize the total number of reads. Hard disk drive 100 may be programmed to follow a particular sequence based on experimental results or hard disk drive 100 may adaptively determine a sequence based on a measurement. In this manner, the techniques described herein may be used to improve DRP.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing signals read from a disk of a hard disk drive, the method comprising:
generating a signal associated with a first position within a width of the data track;
generating a signal associated with a second position within a width of the data track;
combining the signal associated with the first position and the signal associated with the second position; and
applying a finite impulse response filter to the combined signal.

2. The method of claim 1, wherein generating the signal associated with the first position includes reading a magnetization pattern at the first position and applying a zeroing forcing equalization to the read magnetization pattern.

3. The method of claim 2, wherein generating the signal associated with the first position further includes applying a finite impulse response filter to the read magnetization pattern.

4. The method of claim 3, wherein generating the signal associated with the second position includes reading a magnetization pattern at the second position and applying a zeroing forcing equalization and a finite impulse response filter to the read magnetization pattern.

5. The method of claim 1, wherein generating a signal associated with the first position and generating a signal associated with the second position includes generating the signals simultaneously using multi-head simultaneous read.

6. The method of claim 1, wherein applying a finite impulse response filter to the combined signal includes applying a discrete time finite impulse.

7. The method of claim 1, wherein the first position is located at the center of the data track and the second position is located at a distance of approximately ten percent of the track width from the center of the track.

8. The method of claim 8, wherein the track width is 55 nm and the second position is located at approximately 6 nm from the center of the track.

9. The method of claim 1, wherein signals are written to the disk using shingled magnetic recording.

10. A hard disk drive device, the device comprising:
a magnetic disk including a data track written thereon; and
a processing unit configured to:
generate a signal associated with a first position within a width of the data track;
generate a signal associated with a second position within a width of the data track;
combine the signal associated with the first position and the signal associated with the second position; and
apply a finite impulse response filter to the combined signal.

11. The hard disk drive device of claim 10, wherein generating the signal associated with the first position includes reading a magnetization pattern at the first position and applying a zeroing forcing equalization to the read magnetization pattern.

12. The hard disk drive device of claim 11, wherein generating the signal associated with the first position further includes applying a finite impulse response filter to the read magnetization pattern.

13. The hard disk drive device of claim 12, wherein generating the signal associated with the second position includes reading a magnetization pattern at the second position and applying a zeroing forcing equalization and a finite impulse response filter to the read magnetization pattern.

14. The hard disk drive device of claim 10, wherein generating a signal associated with the first position and generating a signal associated with the second position includes generating the signals simultaneously using multi-head simultaneous read.

15. The hard disk drive device of claim 10, wherein applying a finite impulse response filter to the combined signal includes applying a discrete time finite impulse.

16. The hard disk drive device of claim 10, wherein the first position is located at the center of the data track and the second position is located at a distance of approximately ten percent of the track width from the center of the track.

17. The hard disk drive device of claim 16, wherein the track width is 55 nm and the second position is located at approximately 6 nm from the center of the track.

18. The hard disk drive device of claim 10, wherein signals are written to the disk using shingled magnetic recording.

19. A method of processing signals read from a disk of a hard disk drive, the method comprising:
reading a magnetization pattern at a first position within a shingled magnetic recording track and applying a zeroing forcing equalization to the first read magnetization pattern;
reading a magnetization pattern at a second position within the shingled magnetic recording track and applying a zeroing forcing equalization to the second read magnetization pattern;
reading a magnetization pattern at a third position within the shingled magnetic recording track and applying a zeroing forcing equalization to the third read magnetization pattern; and
combining the equalized first read magnetic pattern, the equalized second read magnetic pattern, and the equalized third read magnetic pattern.

20. The method of claim 19, wherein the first position is located at the center of the data track and wherein the track width is approximately 55 nm.
